(19) United States
(12) Patent Application Publication
(10) Pub. No.: US 2004/0101605 A1
(43) Pub. Date: May 27, 2004

(54) Handheld sandwich package

(76) Inventor: Lloyd M. Sigel, Naples, FL (US)

Correspondence Address: Robert V. Vickers, Esq., Fay, Sharpe, Fagan,, Minnich & McKee, LLP, 1100 Superior Avenue, 7th Floor, Cleveland, OH, 44114-2579, US

(21) Appl. No.: 10/305,732

(22) Filed: Nov. 25, 2002

(51) Int. Cl. A23B 4/00

(52) U.S. Cl. 426/394

(57) ABSTRACT

A handheld sandwich package is provided. The handheld sandwich package includes a packaging structure having a cavity occupied by an associated sandwich. The associated sandwich is contained within the cavity when the packaging structure is intact. A first section of the packaging structure defines a first portion of the cavity. The first section is appropriately sized to be graspable by an individual. A second section of the packaging structure defines a second portion of the cavity and is removable from the first section to reveal the associated sandwich. An opening is defined by the first section when the second section is removed therefrom. The opening is connected to the first portion of the cavity. The associated sandwich is seated in the first portion of the cavity and extends through the opening and when the second section is removed the associated sandwich is capable of being held in the first portion of the cavity by exertion of a force on at least one compressible wall of the first section.

### BACKGROUND OF THE INVENTION

1. Field of the Invention

The present invention relates to a food container and, more particularly, to a handheld sandwich container or package. The present invention finds particular application as a handheld wrap sandwich container for carrying an associated wrap sandwich prior to consumption and serving as a holder of the associated wrap sandwich during consumption and will be described in particular reference thereto. It is to be appreciated, however, that the invention may relate to other similar environments and applications.

2. Discussion of the Art

Consumers increasingly demand more convenient and readily accessible single serving food items and, preferably, desire these single serving food items to be contained within functional packaging. In particular, consumer demand has risen for single serving food items of substance, such as sandwiches, wrap sandwiches and the like, that can be purchased at retail, stored at home and consumed anytime thereafter. Storage at home can include storage in climate controlled environments, such as refrigerators and freezers, which increases the overall variety or type of food items available to the consumer.

When the consumer desires to consume these types of foods items, they often further desire to consume the food item only after it is heated. Microwaves are often the heating medium of choice because they offer a quick and convenient method of heating. To further increase the convenience to the consumer, it is often desirable to be able to heat the food items in the microwave without having to remove the food item from its individual packaging container. This increases food preparation efficiency and reduces the need for a separate cooking vessel, such as a bowl or plate, when heating the food item.

Additionally, it is desirable to have a food item in a packaging structure that could, after heating, be easily opened to provide access to the food item and, optionally, hold the food item during consumption thereof. This would reduce the need for a separate eating vessel, such as a bowl or plate, and could allow food items that are relatively hot to be held without discomfort.

Thus, there is a need for a new and improved food item container or package such as a single serving, handheld sandwich package that will contain and protect the sandwich during shipping, retailing, storing and heating, is easily opened to gain access to the sandwich contained therein and can also serve as a holder of the sandwich after heating for consumption thereof. The present invention provides a new and improved food item package that overcomes the foregoing difficulties and others and provides the aforementioned and other advantageous features.

### THE INVENTION

In accordance with one aspect of the present invention, a new and improved handheld sandwich package is provided. More particularly, in accordance with this aspect of the invention, the handheld sandwich package includes a packaging structure having a cavity occupied by an associated sandwich. The associated sandwich is contained within the cavity when the packaging structure is intact. A first section of the packaging structure defines a first portion of the cavity. The first section is appropriately sized to be graspable by an individual. A second section of the packaging structure defines a second portion of the cavity and is removable from the first section to reveal the associated sandwich. An opening is defined by the first section when the section is removed therefrom. The opening is connected to the first portion of the cavity. The associated sandwich is seated in the first portion of the cavity and extends through the opening. When the second section is removed, the associated sandwich is capable of being held in the first portion of the cavity by exertion of a force on at least one compressible wall of the first section.

According to another aspect of the present invention, a new and improved food item container is provided. More particularly, in accordance with this aspect of the invention, the food item container includes a first section of a paperboard material and a second section of a paperboard material connected to the first section. The second section is selectively removable from the first section. A cavity is defined by the first and second sections for receiving an associated food item. A tear strip is disposed on the second section for facilitating removal of the second section from the first section. The first section is capable of holding the food item after the second section is removed from the first section when an individual grasps the first section.

According to yet another aspect of the present invention, a new and improved hand held sandwich package is provided. More particularly, in accordance with this aspect of the invention, the hand held sandwich package includes a first tubular section with a lower closure wall and a second tubular section with an upper closure wall. A removable tear strip joins the first and second tubular sections. The sections define a sandwich receiving cavity when the tear strip is in place with the package surrounding the sandwich. Only the first tubular section holds the sandwich when the tear strip is removed.

Accordingly to still another aspect of the present invention, a new and improved method of preparing and individual food item for consumption thereof is provided. More particular, in accordance with this aspect of the invention, the method includes the steps of removing an outer film from an individual food package. The food package is heated to heat a sandwich contained therein. A top portion of the food package is removed to gain access to the sandwich for consuming the sandwich. The remaining portion of the food package is used as a holder of the sandwich while the sandwich is consumed.

### BRIEF DESCRIPTION OF THE DRAWINGS

The invention may take physical form in various components and arrangements of components, and in various steps and arrangements of steps. The drawings are for purposes of illustrating a preferred embodiment only and are not to be construed as limiting the invention.

FIG. 1 is a front perspective view of the handheld sandwich package according to a preferred embodiment of the present invention.

FIG. 2 is a rear perspective view of the handheld sandwich package of FIG. 1.

FIG. 3 is a top plan view of the handheld sandwich package of FIG. 1.

FIG. 4 is a cross-section view of the handheld sandwich package taken along the line 4-4 of FIG. 1.

FIG. 5 is a perspective view of an individual detaching a second section of the handheld sandwich package of FIG. 1 from a first section to gain access to an associated sandwich.

FIG. 6 is a perspective view of an individual holding the first section of the handheld sandwich package of FIG. 5 after the second section is detached therefrom for consumption of the sandwich.

FIG. 7 is a plan view of the handheld sandwich package of FIG. 1 shown in an unassembled state.

### Preferred Embodiments

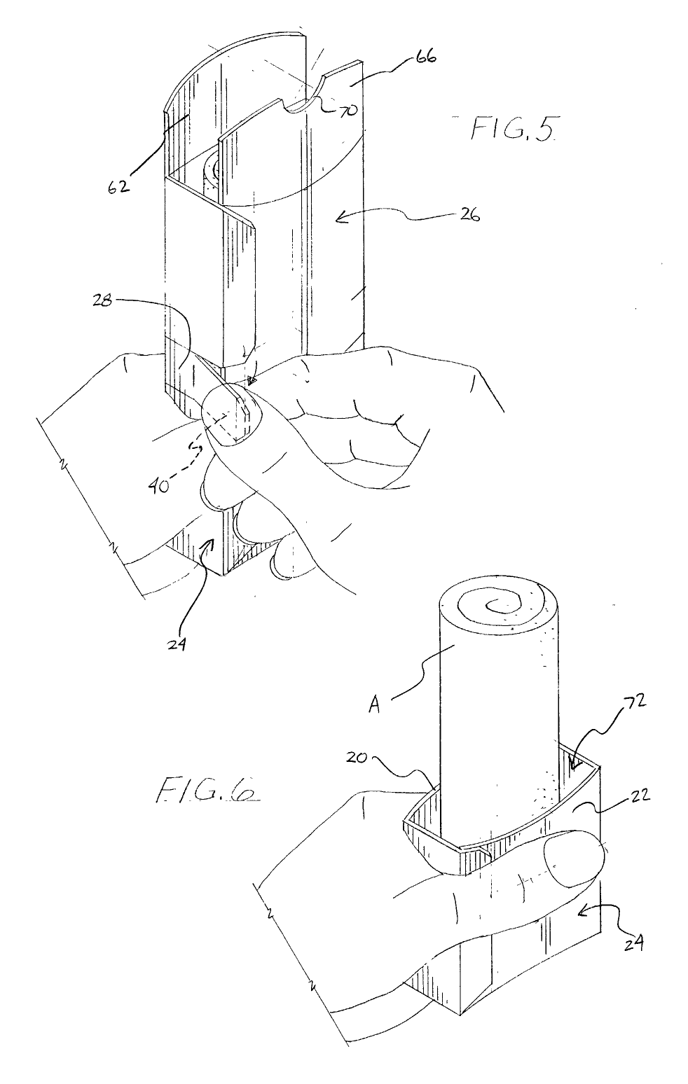

Referring now to the drawings wherein the showings are for purposes of illustrating the preferred embodiment of the invention only and not for purposes of limiting the same, FIG. 1 shows a handheld wrap sandwich container 10 in an assembled state according to a preferred embodiment of the present invention. The single serving sandwich container 10 is a hollow and generally elongated box-like package suitable for carrying a food item such as a handheld wrap sandwich A (See FIG. 4). The sandwich container 10 has a first end 12 spaced apart from a second end 14 with a plurality of sides 16,18,20,22 extending therebetween. More specifically, with additional reference to FIG. 3, two of the sides 16,18 are rectangular-shaped and generally parallel with one another whereas the remaining two sides 20,22 billow outwardly and connect the spaced apart rectangular sides 16,18 together along their respective side edges.

With reference back to FIG. 1, the sandwich container or packaging structure 10 includes a first tubular section 24 adjacent the first end 12 and a second tubular section 26 adjacent the second end 14. The lower portion or first section 24 is made up of the first end 12, also referred to herein as a lower closure wall, and first portions of the sides or side walls 16-22. Similarly, the upper portion or second section 26 is made up of the second end 14, also referred to herein as an upper closure wall, and second portions of the sides or side walls 16-22. A removeable tear strip 28 is sandwiched between and joins the first and second sections 24,26. The tear strip 28 is adapted for removing the second or removable section 26 from the first section 24 as will be described in more detail below.

With additional reference to FIG. 4, the packaging structure 10 defines a sandwich receiving cavity 30 that can be occupied by the handheld sandwich A. When the packaging structure 10 is intact, i.e., the tear strip 28 is in place and has not been pulled to remove the second section 26 from the first section 24 and the packaging structure 10 is otherwise in the form shown in FIG. 1 thereby surrounding the sandwich A, the handheld sandwich A received in the cavity 30 is generally contained therein. As is well known in the art, a plastic film can be added to the packaging structure 10 to further contain the sandwich A within the cavity 30 and, perhaps more importantly, prevent the cavity 30 from becoming contaminated by the surrounding environment and evidence tampering with the food item A.

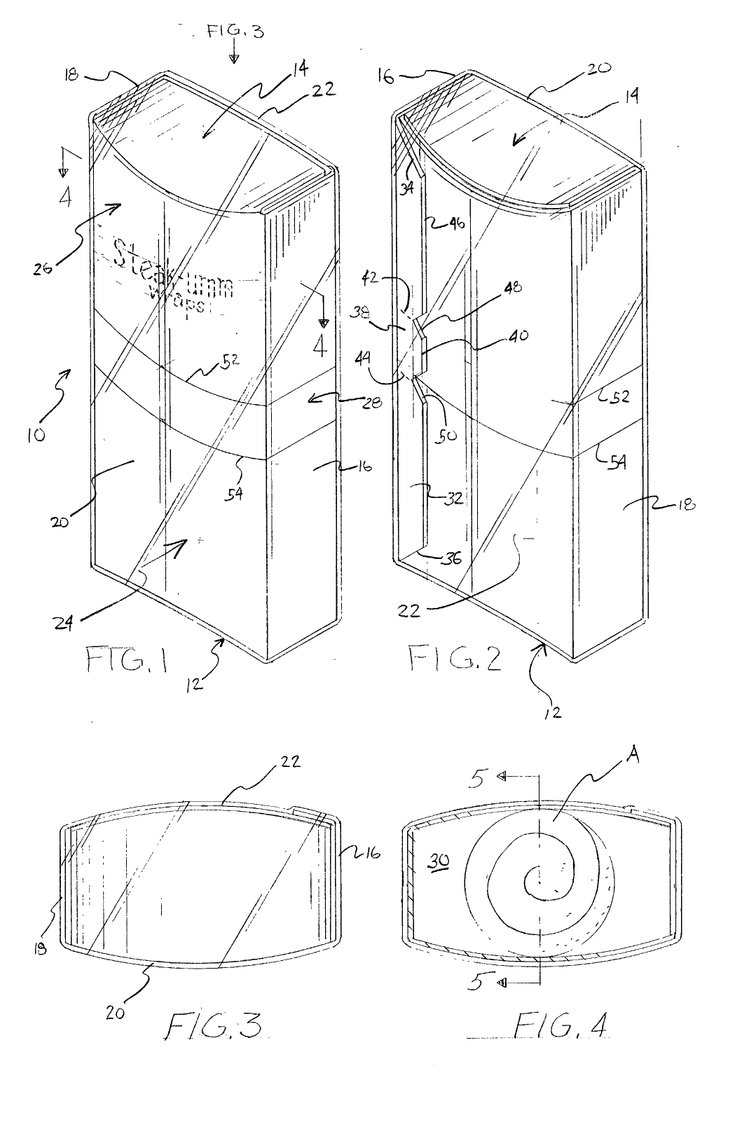

With reference to FIG. 2, a connecting tab 32 overlaps a portion of the rear billowed side 22 to help hold the shape of the packaging structure 10. The connecting tab 32 extends from and connects to the adjacent rectangular side 16. Further, the connecting tab 32 extends along a substantial portion of the length of the side 22. Near the first and second ends 12,14, the connecting tab 32 includes angled edges 34,36 so as to not interfere with respective intersections between the side 22 and the first end 12 and the side 22 and the second end 14. A suitable adhesive can be used to hold the connecting tab 32 to the overlapped side 22.

At a central location along the connecting tab 32, a first end 38 of the tear strip 28 is defined. More specifically, a pull tab portion 40 of the tear strip 28 is formed in the connecting tab 32 by a pair of spaced apart perforations 42,44. Along a distal edge 46 of the connecting tab 32, a pair of notches 48,50 further defines the pull tab portion 40 and allows the pull tab portion 40 to be relatively easily graspable. Once grasped, the pull tab portion 40 can be pulled to remove the tear strip 28 from the packaging structure 10 as will be described in more detail below. With reference to FIG. 1, the remainder of the tear strip 28, i.e., that defined in the sides 16-22, is defined by a pair of weakening lines or score marks 52,54 disposed in the sides 16-22. The score marks 52,54 allow the tear strip 28 to be relatively easily pulled away from the first and second sections 24,26. The arrangement of the score marks 52,54 are such that when the tear strip 28 is fully pulled and removed, the second section 26 is physically separated from the first remaining section 24.

With reference to FIG. 7, the packaging structure 10 is shown in an unassembled state. To make the packaging structure 10, the shape shown in FIG. 7 is cut from a single sheet of a suitable material such as a paperboard material or another material having sufficient strength, stiffness and durability to withstand loads associated with shipping, handling, etc., in commercial use. The container is also preferably capable of withstanding exposure to microwave radiation, heat, steam, and hot water during microwave cooking of the food product A contained therein. Fold or score lines 60 can be added through conventional means to ease in the assembly of the packaging structure 10. Likewise, the score marks or lines 52,54 and the perforation lines 42,44 of the tear strip 28 can be added through conventional means.

To assemble, the rectangular side 18 is folded and oriented generally perpendicularly relative to the front billowing side 20 and end flaps 62,64 connected to the side 20. The side 22 and end flaps 66,68 connected thereto are folded and oriented generally perpendicularly relative to the side 18 and parallel to the side 20 and its end flaps 62,64. The side 16 is then folded and oriented perpendicularly relative to the sides 20,22 and the end flaps 62-68. The connecting tab 32 is folded along the fold line 60 separating the connecting tab 32 from the rectangular side 16 to overlap the rear side 22 (See FIG. 2). As mentioned above, an adhesive can be used to secure the connecting tab 32 to the overlapped side 22 as is well known in the art.

Next, the first and second ends 12,14 (FIG. 1) can be formed. More specifically, one of the end flaps 68 at the first end 12 can be folded inward toward the other end flap 64 at the first end 12. The other end flap 64 can then be folded to overlap the first folded end flap 68. Again, an adhesive can be used to secure the second folded end flap 64 to the first folded end flap 68. Similarly, one of the end flaps 66 at the second end 14 which optionally includes a notch 70, can be folded toward the other end flap 62 at the second end 14. The other end flap 62 can then be folded to overlap the first folded end flap 66 and an adhesive can be used to secure the two end flaps 62,66 together. The folding of the end flaps 62-68 causes the sides 20,22 to billow outwardly from one another as can be seen in FIG. 3.

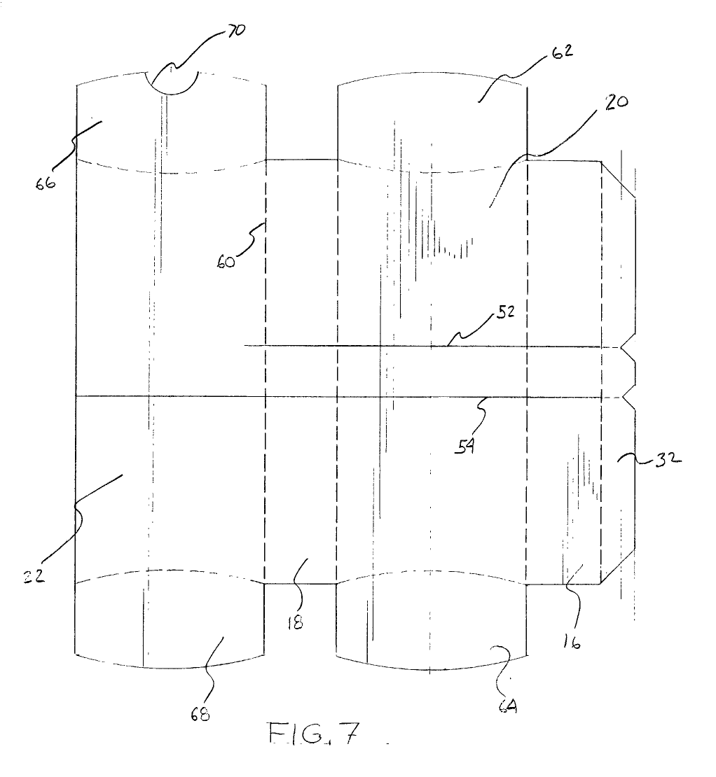

If the packaging structure 10 and its contents A are to be heated, it may be desirable to remove the outer plastic film from the packaging structure 10 when an outer plastic film is used on the packaging structure 10. It may be further desirable to open at least one end of the packaging structure 10 prior to heating to allow heat such as steam created during heating to escape from the cavity 30 of the packaging structure 10. This may reduce the likelihood that someone would be injured by escaping heat when opening the packaging structure 10 after heating. For this purpose, the second end 14 is designed to be opened with relative ease. The second end 14 and, specifically, the overlapping flap 62 can include printed indicia explaining that the second end 14 is the preferred end to be opened. To open the second end 14, the overlapping flap 62 is pulled apart from the overlapped flap 66 thereby revealing the overlapped flap 66. The overlapped flap 66 can include additional printed indicia also explaining that the second end 14 is the preferred end to be opened and opening thereof should be continued. Next, the overlapped flap 66 is pulled open to reveal the cavity 30 and the sandwich A occupying the cavity 30 (See FIG. 5). The notch 70 in the overlapped flap 64 is engageable by an individual's finger to facilitate the pulling open of the flap 66. The first end 12 can also include indicia on one or both of the flaps 64,68 to indicate that it is not the appropriate end to be opened during heating.

With the film removed and the second end 14 opened, the packaging structure 10 and its contents A can be heated by, for example, microwaving the packaging structure 10 and the sandwich A held therein. Any of the sides 16-22 or the ends 12,14 can include heating instructions and/or after-heating temperature warnings. After heating, the package 10 can be removed from the heating source, such as a microwave, carefully so as to keep the sandwich A within the package 10. Then, with reference to FIG. 5, an individual can hold the first section 24 in one hand while pulling the tear strip 28 with his or her other hand to remove the second section 26 from the first section 24 and thereby reveal a substantial portion of the sandwich A for consumption thereof.

More specifically, the individual can apply pressure with a first hand to the billowing sides 20,22 of the packaging structure or container 10 to hold the sandwich A in position. With additional reference to FIG. 3, the shape of the packaging structure 10 is generally a shape that corresponds or matches the shape of one's hand when grasping an object between the thumb and the four other fingers of that hand. Thus, the packaging structure 10 and, particularly, the first section 24 are appropriately sized to be graspable and easily held by an individual.

With a second hand, the individual can use a finger to wedge open the pull tab portion 40, i.e., break the perforations 42,44 holding the pull tab portion 40 to the remainder of the connecting tab 32. Then, the pull tab portion 40 can be easily grasped and pulled, as shown in FIG. 5, to remove the pull strip 28 from the first section 24 of the packaging structure 10. Because, with reference to FIGS. 1 and 2, the lower score mark 54 adjacent the lower section 24 extends around the entire packaging structure 10 (around the entire perimeter of the cavity 30) and the upper score mark 52 extends around only a portion of the packaging structure 10, the tear strip 28 will not completely separate from the second section 26. Instead, continued pulling of the tear strip 28 will cause the tear strip 28 and the second section 26 to together separate from the first section 24. Thus, in the first hand, the individual will have the first section 24 with the sandwich A and, in the second hand, the individual will have the removed tear strip 28 with the second section 26 attached thereto. The second section 26 can then be discarded.

With reference to FIG. 6, with the second section 26 removed, the sandwich A is revealed through an opening 72 defined in the first section 24. The opening 70 is connected and leads a first portion of the cavity 30 defined by the first section 24. As mentioned above, the second section 26 which defined a second portion of the cavity 30 can be discarded after being removed from the first section 24. The sandwich A is seated in the first portion of the cavity 30 and extends through the opening 70. The individual can continue holding only the first section 24 in his or her hand and use only the first section 24 as a holder of the sandwich A while the sandwich A is consumed. Exertion of a force or pressure on the opposed compressible sides or walls 20,22 of the packaging structure 10, such as a grasping force between the individuals thumb and other four fingers, can be applied to maintain the sandwich A within the remaining first section 24. One of the benefits or advantages of the present invention is the provision of a food item packaging structure 10 that permits a user to heat a food item A contained therein and consume the food item A therefrom without physically removing the food item A from the packaging structure 10. Further, if the food item A is too hot for holding directly after heating, the food item A can still be held via the first section 24.

Although the present invention is illustrated and described as a package, packaging structure or container for holding a wrap sandwich, it should be appreciated that other food items may be used with the present invention. The present invention provides a packaging structure for a food item that contains the item and allows the item to be held by at least a portion of the packaging structure during consumption of the food item. It is not necessary that the food item be a wrap sandwich or even have a shape similar to the wrap sandwich illustrated and described herein. Thus, it is contemplated that other food items can be used with the present invention and all such food items that would be known to those skilled in the art are to be considered within the scope of the present invention.

The invention has been described with reference to a preferred embodiment. Obviously, modifications and alterations will occur to other upon reading and understanding the preceding detailed description. It is intended that the invention be construed as including all such modifications and alterations insofar as they are within the scope of the appended claims and equivalents thereof.

Having thus described the preferred embodiments, the invention is now claimed to be:

1. A handheld sandwich package, comprising:
a packaging structure having a cavity occupied by an associated sandwich, the associated sandwich contained within the cavity when the packaging structure is intact;
a first section of the packaging structure defining a first portion of the cavity, the first section appropriately sized to be graspable by an individual;
a second section of the packaging structure defining a second portion of the cavity and removable from the first section to reveal the associated sandwich;
an opening defined by the first section when the second section is removed therefrom, the opening connected to the first portion of the cavity; and
wherein the associated sandwich is seated in the first portion of the cavity and extends through the opening and when the second section is removed the associated sandwich is capable of being held in the first portion of the cavity by exertion of a force on at least one compressible wall of the first section.

2. The handheld sandwich package of claim 1 further comprising:
a tear strip for readily removing the second section from the first section.

3. The handheld sandwich package of claim 2 wherein the tear strip is defined by an upper score mark and a lower score mark adjacent the second section, the lower score mark extends around substantially the entire packaging structure and the upper score mark extends around less than the entire packaging structure.

4. The handheld sandwich package of claim 2 wherein the tear strip includes a pull tab portion at one end for facilitating grasping and pulling of the tear strip.

5. The handheld sandwich package of claim 4 wherein the pull tab portion is defined by a pair of perforations that are readily broken to release the pull tab portion.

6. The handheld sandwich package of claim 1 wherein the second section includes a pair of flaps that can be opened for allowing heat to escape from the cavity during heating of the package structure and the associated sandwich.

7. The handheld sandwich package of claim 6 wherein at least one of the pair of flaps can include a notch for facilitating opening of the at least one of the pair of flaps.

8. The handheld sandwich package of claim 1 further comprising:
a plastic film wrapped around the packaging structure.

9. The handheld sandwich package of claim 1 wherein the at least one compressible wall of the first section is a pair of opposing, billowing walls connecting to one another along their side edges by a pair of opposing rectangular walls.

10. A food item container, comprising:
a first section of a paperboard material;
a second section of a paperboard material connected to the first section, the second section selectively removable from the first section;
a cavity defined by the first and second sections for receiving an associated food item;
a tear strip disposed on the second section for facilitating removal of the second section from the first section; and
wherein the first section is capable of holding the food item after the second section is removed from the first section when an individual grasps the first section.

11. The food item container of claim 10 wherein the first section is generally shaped to match the grasping shape of an individual's hand between the thumb and four fingers of the hand.

12. The food item container of claim 11 wherein the first section is defined by two opposing rectangular sides and two opposing billowing sides that connect between the rectangular sides.

13. The food item container of claim 10 wherein the tear strip includes a pull tab portion defined by perforations, the pull tab portion selectively breakable along the perforations and graspable to facilitate pulling of the tear strip.

14. The food item container of claim 13 wherein the tear strip is defined by a pair of score marks, one of the pair of score marks extends around the entire cavity between the first and second sections and the other of the pair of score marks extends only partially around the cavity thereby leaving the tear strip connected to the second section upon removal of the second section from the first section.

15. The food item container of claim 10 wherein the second section includes a pair of end flaps openable to the cavity for allowing heat to escape from the cavity wherein at least one of the pair of end flaps includes a notch to facilitate opening of at least one of the pair of end flaps.

16. A hand held sandwich package, comprising:
a first tubular section with a lower closure wall;
a second tubular section with an upper closure wall; and
a removable tear strip joining the first and second tubular sections whereby the sections define a sandwich receiving cavity when said tear strip is in place with the package surrounding the sandwich and only the first tubular section for holding said sandwich when said tear strip is removed.

17. The hand held sandwich package of claim 16 wherein the first tubular section has opposed, collapsible sandwich holder walls.

18. A method of preparing an individual food item for consumption thereof, the method comprising:
heating a food package to heat a sandwich contained therein;
removing an upper portion of the food package from a lower portion to gain access to the sandwich for consuming the sandwich;
using the lower portion of the food package as a holder of the sandwich while the sandwich is consumed.

19. The method of claim 18 wherein the step of removing the upper portion of the food package includes the step of pulling a tear strip to disconnect the upper portion from the lower portion.

20. The method of claim 18 further including the step of:
opening top flaps of the food package prior to heating to allow heat to escape during heating.

21. The method of claim 18 further including the step of:
removing an outer plastic film from the food package.
